(19) United States
(12) Patent Application Publication
(10) Pub. No.: US 2026/0091427 A1
(43) Pub. Date: Apr. 2, 2026

(54) CONTINUOUS PRODUCTION OF WIRE FEEDSTOCK USING THERMOACOUSTIC CONSOLIDATION OF POWDERS

(71) Applicant: KENG HSU, Phoenix, AZ (US)

(72) Inventor: KENG HSU, Phoenix, AZ (US)

(21) Appl. No.: 19/343,980

(22) Filed: Sep. 29, 2025

Related U.S. Application Data
(60) Provisional application No. 63/702,419, filed on Oct. 2, 2024.

(51) Int. Cl. B22F 3/093; B22F 3/03; B22F 10/73; B33Y 40/10

(52) U.S. Cl. CPC B22F 3/093; B22F 3/03; B22F 10/73; B33Y 40/10

(57) ABSTRACT

A method of producing a metal wire feedstock for additive manufacturing and/or welding, the method includes baking a metal powder to remove humidity and moisture from the metal powder, transferring ultrasonic energy into the metal powder via a roller of a roll-forming die, transferring vibration energy from the roll-forming die to the metal powder, converting the metal powder into the metal wire feedstock via solid-state fusion on particle-particle interfaces of the metal powder, and increasing a ductility of the metal wire feedstock via heat.

### CROSS-REFERENCE TO RELATED APPLICATIONS

This application claims priority to U.S. Provisional Patent Application No. 63/702,419, filed Oct. 2, 2024, the entire contents of which are incorporated herein by reference.

### BACKGROUND

Laser Powder Bed Fusion (LPBF) is an additive manufacturing (AM) process that creates parts via consecutive layers. In LPBF printing, a laser selectively melts powdered metal particles, fusing them together to build an object, for example, an object design via 3D modeling. Each layer of powder is spread across a build platform and selectively sintered by a laser tracing the design of the layer, solidifying the desired material. After a layer is completed, the build platform is lowered, and another layer of powder is added atop the previous layer.

### SUMMARY

A new thermoacoustic consolidation method processes out-of-spec LPBF metal powder and produces continuous/discrete feedstocks for direct use in other metal AM processes such as directed energy deposition (DED) or wire arc additive manufacturing (WAAM), or other manufacturing processes such as metal inert gas (MIG) and tungsten inert gas (TIG) welding. By applying both low heat (less than ⅓ melting temperature) and ultrasonic vibration energy, the consolidation and solid-state fusion bonding of powder particles occurs rapidly and reaches high densities in the consolidated product (greater than 99%). Further, this low temperature, rapid process can be integrated into a continuous production tool where both the ultrasonic and thermal energy are applied to the powder in a roll forming environment to provide continuous production of wire feedstocks using this approach.

The current common practices in LPBF technology are based on a powder lifecycle where an estimated 20-30% of powder feedstock acquired in the upstream of the production process ends up in storage after 5-10 times of sieving and reclaiming for reuse. Reclaimed powder in this state has a particle (and geometry) distribution that deviates from the required specification and can cause build defects and even failures as a result of recoating issues. There are no feasible ways currently for these out-of-spec powders to reenter into the material recycle flow and return to the refinery or powder manufacturers. The most common approach for dealing with these powders is to accumulate and store them in manufacturing facilities. These stored powders not only present logistic, resource, and cost issues, but they also increase safety and security risks. Demonstration of innovative recycling processes are sought after. Further, developing an economically viable, environmentally friendly process for recycling of AM powders from the existing manufacturing process could facilitate the establishment of a viable, competitive domestic AM feedstock supply chain.

The proposed technology of continuous thermoacoustic consolidation of LPBF powder for wire feedstock production utilizes out-of-spec reclaimed metal powders to produce solid metal wire feedstocks. These solid wire feedstocks have several advantages over the powder form of the same material. From storage and handling perspective, these solid wire feedstocks eliminate the hazardous and safety risks associated with metal powders, particularly when reactive metal such as aluminum and titanium alloys are used. Additionally, the wire feedstocks produced by the proposed technology can in turn be directly used for DED-type metal AM processes, as well as MIG/TIG welding feedstocks. Utilizing low process temperatures and power ultrasonics, this solid-state process is energy efficient, cost effective, and capable of producing, from loose powder, solid feedstocks with over 99% density. Complete systems may be developed based on the concept and implemented locally in service-depots and laboratory facilities where LPBF is in use. The technology converts out-of-spec re-claimed powders into wire feedstocks for storage or for use in other manufacturing processes locally and across various organizations.

The process requires low power/energy consumption, is an all-solid process, requiring no melting or excessive heating, and is scalable in throughput. As such, the process is energy efficient, sustainable, has no solidification or microstructure complexities, and is accessible and deployable.

In some aspects, the techniques described herein relate to a method of producing a metal wire feedstock for additive manufacturing and/or welding, the method including: baking a metal powder to remove humidity and moisture from the metal powder; transferring ultrasonic energy into the metal powder via a roller of a roll-forming die; transferring vibration energy from the roll-forming die to the metal powder; converting the metal powder into the metal wire feedstock via solid-state fusion on particle-particle interfaces of the metal powder; and increasing a ductility of the metal wire feedstock via heat.

In some aspects, the techniques described herein relate to a method, further including using the metal powder in a laser powder bed fusion apparatus prior to baking the metal powder, such that the metal powder is a spent metal powder.

In some aspects, the techniques described herein relate to a method, wherein baking the metal powder includes moving the metal powder along a conveyor.

In some aspects, the techniques described herein relate to a method, wherein the conveyor is an auger-type conveyor.

In some aspects, the techniques described herein relate to a method, wherein the conveyor applies an initial compaction force to the metal powder.

In some aspects, the techniques described herein relate to a method, wherein transferring vibration energy from the roll-forming die to the metal powder provides acoustic softening and frictional heating to the metal powder.

In some aspects, the techniques described herein relate to a method, wherein increasing the ductility of the metal wire feedstock via heat includes receiving heat from an external heat source.

In some aspects, the techniques described herein relate to a method of recycling a spent metal powder from a laser powder bed fusion apparatus, the method including: applying heat at a temperature less than a melting temperature of the spent metal powder to the spent metal powder; applying ultrasonic vibration energy to the spent metal powder; and forming, via the applied heat and ultrasonic vibration energy, a wire feedstock.

In some aspects, the techniques described herein relate to a method, further including utilizing the wire feedstock in a directed energy deposition apparatus or a wire arc additive manufacturing apparatus.

In some aspects, the techniques described herein relate to a method, further including utilizing the wire feedstock in a metal inert gas welder or a tungsten inert gas welder.

In some aspects, the techniques described herein relate to a thermoacoustic ultrasonic roll-forming consolidation system including: a hopper configured to receive a metal powder; a shaping anvil; a roller configured to rotate relative to the shaping anvil, wherein a compression and consolidation zone is formed by and between the roller and the shaping anvil. a conveyor configured to convey the metal powder from the hopper to the compression and consolidation zone, wherein the roller and the shaping anvil are configured to convert the metal powder into a metal wire feedstock via solid-state fusion on particle-particle interfaces of the metal powder.

In some aspects, the techniques described herein relate to a thermoacoustic ultrasonic roll-forming consolidation system, further including an ultrasonic transducer, wherein the roller is configured to transfer ultrasonic energy from the ultrasonic transducer into the metal powder.

In some aspects, the techniques described herein relate to a thermoacoustic ultrasonic roll-forming consolidation system, further including a heat source configured to bake the metal powder at the conveyor.

In some aspects, the techniques described herein relate to a thermoacoustic ultrasonic roll-forming consolidation system, wherein the roller includes a semicircular profile, wherein the shaping anvil has a semicircular profile, wherein the semicircular profiles of the roller and the shaping anvil cooperate to form a circular cross-section of the metal wire feedstock.

In some aspects, the techniques described herein relate to a thermoacoustic ultrasonic roll-forming consolidation system, wherein the conveyor includes an auger configured to transfer the metal powder away from the hopper and towards the compression and consolidation zone.

In some aspects, the techniques described herein relate to a thermoacoustic ultrasonic roll-forming consolidation system, wherein the roller is supported by a pair of bearings.

In some aspects, the techniques described herein relate to a thermoacoustic ultrasonic roll-forming consolidation system, wherein the conveyor applies an initial compaction force to the metal powder.

In some aspects, the techniques described herein relate to a thermoacoustic ultrasonic roll-forming consolidation system, wherein the conveyor includes an auger, and wherein the roller is rotatable about an axis that is perpendicular to a rotational axis of the auger.

In some aspects, the techniques described herein relate to a thermoacoustic ultrasonic roll-forming consolidation system, wherein the conveyor includes a linear actuator, and wherein the roller is rotatable about an axis that is perpendicular to a motion direction of the linear actuator.

In some aspects, the techniques described herein relate to a thermoacoustic ultrasonic roll-forming consolidation system, wherein a diameter of the metal wire feedstock is less than an inner diameter of the conveyor.

### BRIEF DESCRIPTION OF THE DRAWINGS

FIG. 1 is a flowchart illustrating metal powder feedstock lifecycle in laser powder bed fusion (LPBF).

FIG. 2A illustrates a front view of wire feedstock production based on thermo-acoustic consolidation of reclaimed LPBF metal powder.

FIG. 2B illustrates a side view of wire feedstock production based on thermo-acoustic consolidation of reclaimed LPBF metal powder.

FIG. 3 illustrates thermoacoustic consolidation as metal powder goes through a four stage solid-state process to become solid feedstock.

FIG. 4 illustrates a thermoacoustic ultrasonic roll-forming consolidation test rig.

FIG. 5 illustrates a semi-continuous ultrasonic roll-forming consolidation setup.

FIG. 6 illustrates initial consolidation results.

FIG. 7 illustrates ultrasonically consolidated pure copper.

### DETAILED DESCRIPTION

The present application outlines an approach that sustainable additive manufacturing practices through material handling, recycling/reuse, and the creation of completely new markets and value streams out of what is considered a “waste” stream of metal powder from Additive Manufacturing. This helps AM become a more sustainable and environmentally responsible technology, by creating value streams for the estimated 20% of metal powder material waste currently experienced in the manufacturing process.

Technologies are developed that provide new value chains for the “waste” stream of used metal powder. The technology allows for the reuse of AM Materials, leading to a more sustainable product life cycle for these materials. The benefits of this reuse include the diversion of the used AM powder material from landfills or other forms of waste disposal, and reduced energy consumption and carbon emissions associated with the creation of virgin material for the value stream consuming the AM used material (to create wire that can be used just like “new” wire). The technology allows for the reuse of AM materials in a way that can yield repeatable and acceptable performance.

A thermoacoustic consolidation method processes uses LPBF metal powders and produces wire feedstocks for direct use in other metal AM processes such as DED or WAAM, or other manufacturing processes such as MIG and TIG welding. The solid-state process is based on application of low heat (less than ⅓ melting temperature) and ultrasonic vibration energy to consolidate loose metal powder. This solid-state powder consolidation process occurs rapidly (under 10 seconds) and can reach high densities in the end-product (greater than 99%). Further, this low temperature, rapid process can be integrated into a continuous production tool where both the ultrasonic and thermal energy are applied to the powder in a roll forming environment. This approach allows continuous production of wire feedstocks.

The technology is developed to increase the circularity of AM materials and demonstrate there is a value stream for used AM powder materials. If powder AM metal materials can be diverted from the waste stream and reused as feed stock for the wire market, this adds value to both the AM materials waste stream and reduces the energy and carbon emissions needed to produce virgin materials for wire feedstock. This improves the overall sustainability of AM and creates opportunities for material life-cycle circularity. The technology builds sustainability for AM and the markets it supports. In some instances, it may additionally support non-Additive Manufacturing material markets and technologies.

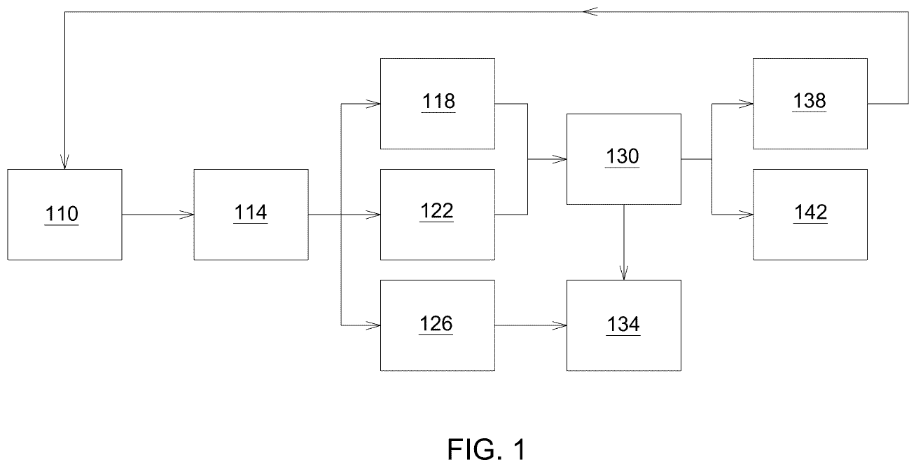

The current common practices in LPBF technology with LBPF apparatuses, are based on a powder lifecycle depicted in FIG. 1 where an estimated 20-30% of powder feedstock acquired in the upstream of the production process ends up in storage after 5-10 times of sieving and reclaiming for reuse. The main issue with the reclaimed powder in this state is that while the material is still chemically and compositionally conforming, the particle and geometry distribution has deviated from that of the virgin powder material and can cause build defects and even failures as a result of recoating issues. There are no feasible ways currently for these used powders to go back to the refinery or powder manufacturers and re-enter into the additive manufacturing material flow. The most common approach to dealing with these powders is to simply accumulate and store them in manufacturing facilities. These stored powders not only present logistics, resource, and cost issues, but they also increase safety and security risks.

Within the flow chart of FIG. 1, the reference numeral 110 corresponds to powder fill that is represented as x % new powder and y % reclaimed powder. This powder is provided to the build process, represented as reference numeral 114. The build process results in reclaimed powder (reference numeral 138) and powder waste (reference numeral 134) via build unpack (reference numeral 118), recoat overflow (reference numeral 122), and chamber clean up (reference numeral 126). Each of these three areas result in powder waste (reference numeral 134), with the powder waste 134 from the build unpack and recoat overflow separating from the reclaimed powder 138 via a reclaimed powder sieve 130. 20-30% of the reclaimed powder from the sieve 130 is non-usable powder 142 after 5-10 times of reclaiming for reuse.

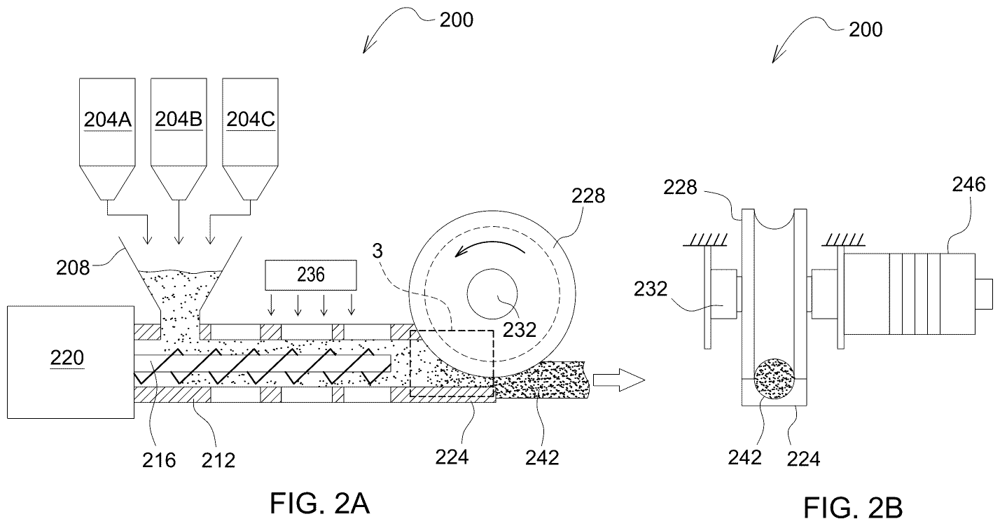

The technique is depicted in FIGS. 2A-2B with a thermoacoustic ultrasonic roll-forming consolidation system 200. The proposed technology of continuous thermoacoustic consolidation of LPBF powder for wire feedstock production utilizes reclaimed metal powders 204A, 204B, 204C to produce solid wire feedstocks 242. These solid wire feedstocks 242 have several advantages over the powder form of the same material. From storage and handling perspective, these solid wire feedstocks 242 eliminate the hazardous and safety risks associated with metal powders, particularly when reactive metal such as aluminum, copper, and titanium alloys are used. Additionally, the wire feedstocks 242 produced by the proposed technology can in turn be directly used for DED-type of metal AM processes, as well as the wire feedstock in a metal inert gas welder or a tungsten inert gas welder. As shown, the solid wire feedstocks 242 are condensed and compressed between the roller 228 and the anvil 224. As such, the diameter of the solid wire feedstock 242 (dictated by the profiles of the roller 228 and anvil 224) is less than an inner diameter of the conveyor 212 within which the auger 216 moves the material.

The proposed innovation is based on the combined phenomena of acoustic softening, acoustic energy enhanced solid-state diffusion, and continuous dynamic microstructure recovery/recrystallization. As the loose re-claimed powder (from one or more different metals 204A, 204B, 204C) enters the powder conveyer 212 (an auger-type conveyer having an auger 216 for linearly displacing the material of the conveyor 212 is shown in FIG. 2), a low temperature bake (e.g., via a heat source 236 such as an external heat source) on the conveyor 212 allows for humidity and moisture accumulated on powder surfaces to evaporate. Other types of conveyors may be utilized in other embodiments. The low temperature bake reduces the chance of gas inclusions during the later stages of the process. As the powder dries and experiences initial compaction from the mechanical forces applied by the conveyer 212, the powder comes in contact with a roller surface of a roller 228 where the ultrasonic energy is transferred into the powder. The powder then goes through a four-stage process as it moves through the compression and consolidation zones between the roller 228 and a shaping anvil 224. At the exit of the roller-anvil contact zone, a solid feedstock 242 is formed and moves towards downstream collection.

The conveyor 212, and in particular, the auger 216 of the conveyor 212 is driven by a power transmission device 220 such as a motor. The auger 216 carries the material from a hopper 208 that receives the metal powder from one or more sources (see metal powders 204A, 204B, 204C) towards the consolidation zone between the roller 228 and the shaping anvil 228. In the embodiment shown, to generate a solid feedstock 242 having a circular cross-section, the roller 228 and the shaping anvil 224 have complementary semicircular cross-sections (see FIG. 2B) that collectively form a circular cross-section at the compression and consolidation zones. The lower anvil 224 in the system 200 that forms the lower half circle of the round feedstock cross-section is made from hardened steel.

The roller 228 is mounted (e.g., via a pair of bearings 232 or other mounts) relative to the conveyor 212 and is rotatable. An ultrasonic transducer 246 is coupled to the disc to input ultrasonic energy at the compression and consolidation zones. In the embodiment shown, the roller 228 rotates about an axis that is perpendicular to a rotational axis of the auger 216.

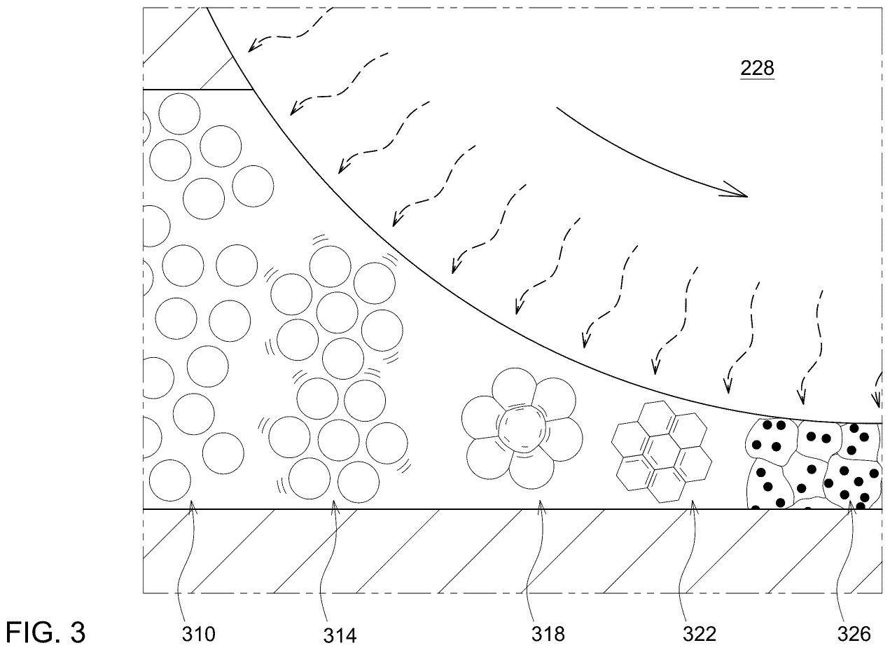

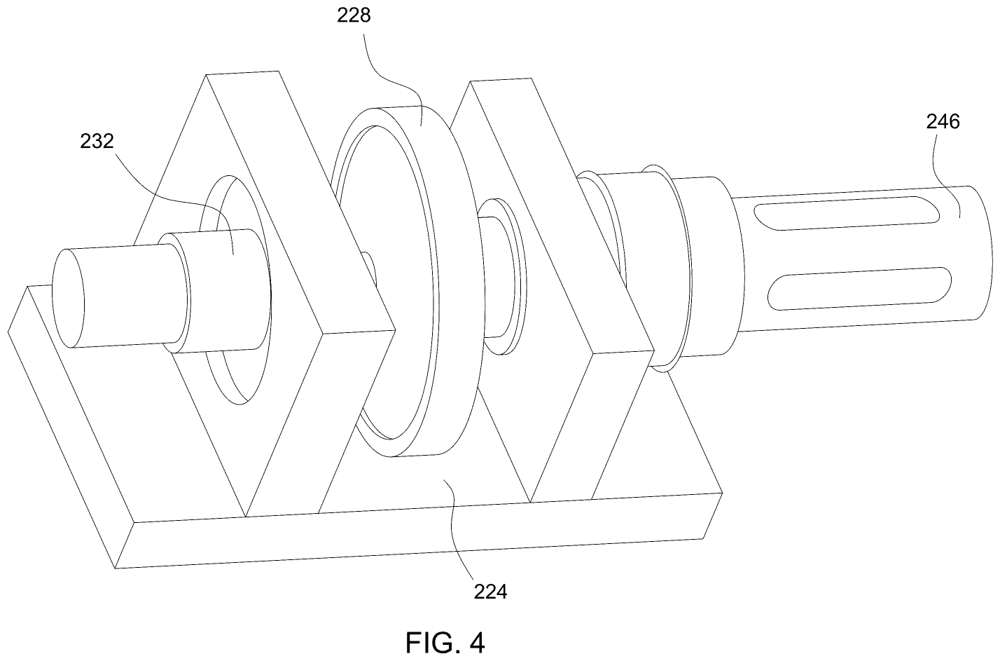

As shown in FIG. 3, the four stages that govern the physical mechanism of the proposed thermoacoustic consolidation process are (1) acoustic energy transfer, (2) particle softening and space filling, (3) particle-to-particle solid-state fusion, and (4) heat induced dynamic recovering. In the first stage of the thermoacoustic consolidation process, the mechanically compacted loose powder 310 becomes mechanically coupled such that vibration energy from the roll-forming die is transferred through the cross-section of the powder passing through the die 314. This allows both acoustic softening 318 and frictional heating to occur both in the bulk of powder particle, and on particle-particle interfaces. The softening of particles allows the compression applied by the roll-forming die to induce large amounts of deformation in powder particles and achieve spacing filling.

As the deformed powder “flows” into the third stage zone 322 where mechanical compression starts to reduce and the density increase slows down, the solid-state fusion on particle-particle interfaces occurs across the entire domain of material. In this stage, acoustic energy-enhanced diffusion occurs across the intimate physical contacts on the interfaces between particles. This phenomenon is also the main mechanism behind other acoustic energy-based manufacturing processes such as Ultrasonic Additive Manufacturing (UAM), Ultrasonic Consolidation (UC), and Directed Acoustic Energy Deposition (DAED) AM. At the end of this stage (as shown by reference numeral 326), the material has effectively converted into full solid form. At this stage, however, it has high dislocation/dislocation cluster density, and sub-grain boundaries, and therefore can be brittle. The last stage of the process utilizes the heat (generated from the previous stage and from externally imposed heating) which enables the dislocation annihilation (reduction of dislocation density), some degree of re-crystallization (dependent on temperature and metal type), and grain growth to occur, allowing the feedstock to effectively anneal and regain ductility.

The proposed thermoacoustic consolidation uses combined acoustic and thermal energy to allow solid-state fusion, consolidation, and shaping to occur within a short time frame (<10 seconds). It results in a cost effective and energy efficient method to process used LPBF metal powder and produce continuous wire/linear feedstocks for direct use in other metal AM processes such as DED or WAAM, or other manufacturing processes such as MIG and TIG welding.

A test rig of a thermoacoustic ultrasonic roll-forming consolidation system 200 including a stationary lower anvil 224 and a motioned controlled ultrasonic roll-forming die 228 demonstrates an initial feasibility of the concept. This test rig 200 consolidates LPBF aluminum F357 powder feedstock into short sections of continuous feedstock 242. The system 200 is based on a COTS ultrasonic seam welding tooling and is modified to ensure the roller profile and resonance are both correct for feasibility validation. An 800 W, 35 kHz ultrasonic system is used to power the process. A mode analysis determines the required geometry modifications on the roller to (1) form the feedstock cross-sectional profile, and to (2) allow for the resonance of the roller die as well as the entire transducer setup to remain with +/−1 kHz of 35 kHz. With the use of a frequency adjustable ultrasonic generator, the required power is provided to the roller die-powder contact and keep the power input controlled while the load varies during a given consolidation process.

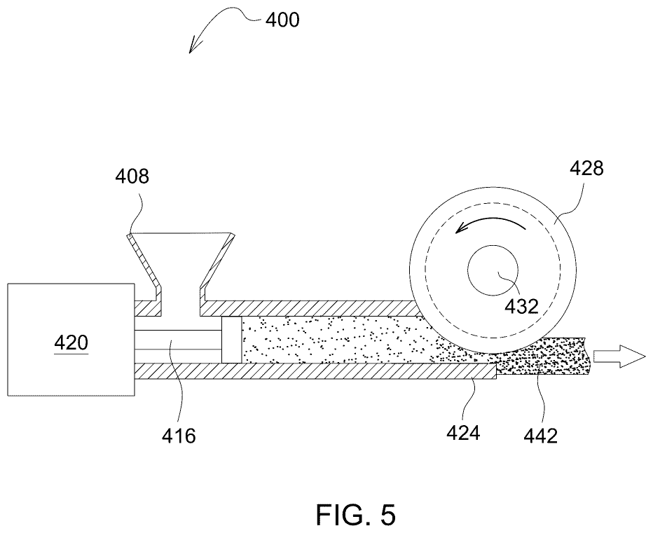

FIG. 5 illustrates an alternative embodiment of a thermoacoustic ultrasonic roll-forming consolidation system 400. Similar elements as those of the thermoacoustic ultrasonic roll-forming consolidation system 200 shown in FIGS. 2A-2B are designated with like reference numerals, incremented by 200. Within the thermoacoustic ultrasonic roll-forming consolidation system 400, the auger is replaced with a linear actuator 416 for compaction and delivery of the powder material to the roller 428 and anvil 424. In the embodiment shown, the roller 428 rotates about an axis that is perpendicular to a motion direction of the linear actuator 416.

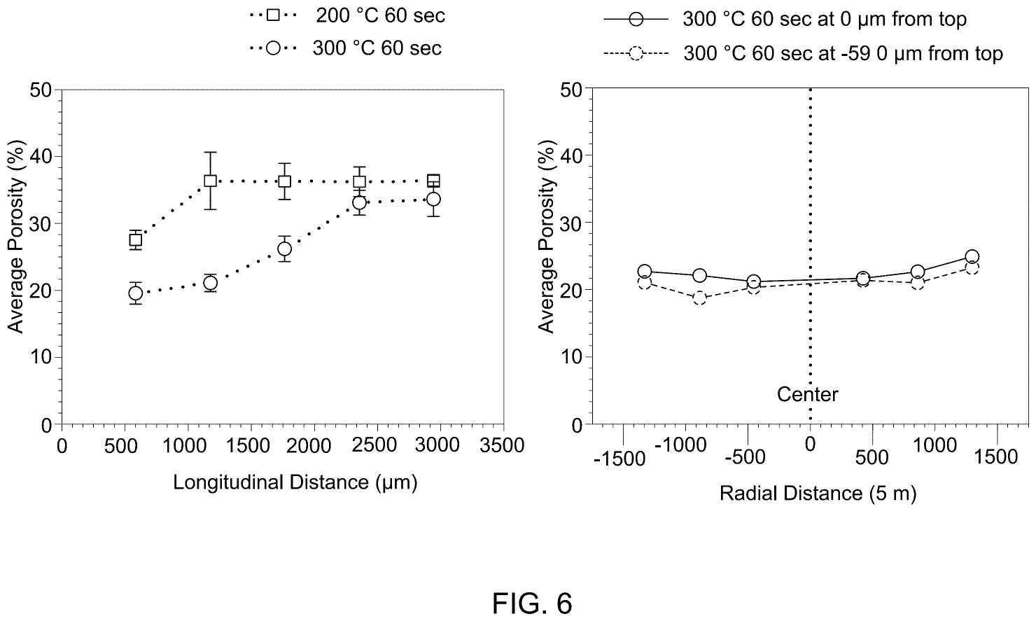

With reference to FIG. 6, semi-static compression-based thermoacoustic consolidation identifies that the concept of consolidating LPBF powder into a solid section of wire is viable, with tests using the test rig generating solid sections of wire with porosity as low as 20%. As expected, across the diameter of the consolidated sample, the density is consistent throughout, while in the axial direction (along the direction of powder travel), changes in the density correspond to the amount of compression the sample experiences at different parts of the roller.

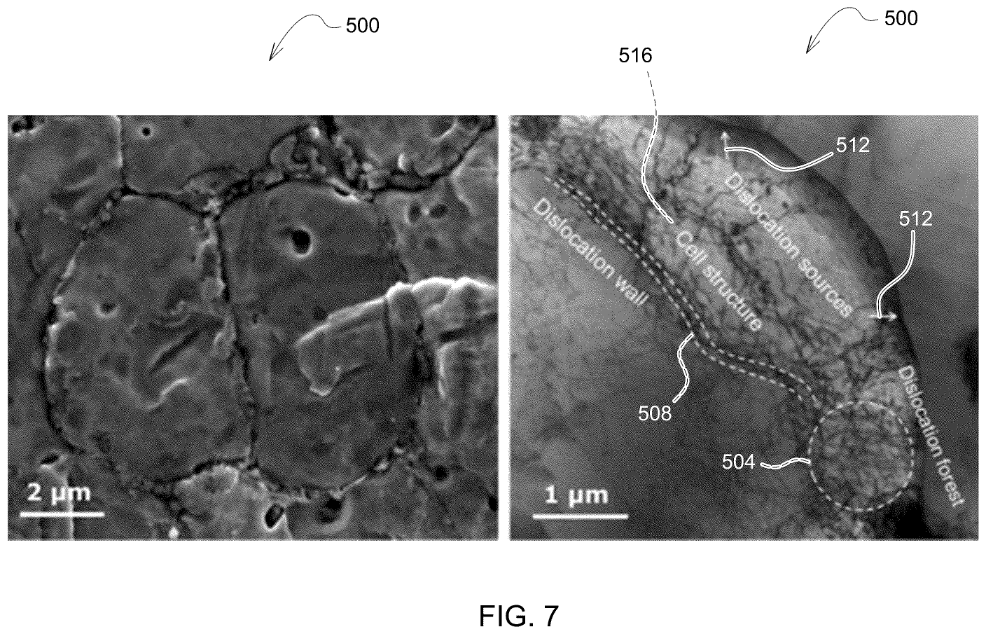

In an alternative setup using static compression, pure copper virgin powder is compressed using a lab-built ultrasonic compression die setup to examine the dependence of powder geometry and space filling on input ultrasonic power when fixed compression, consolidation duration, and temperature are held constant. Under experimental conditions (40 kHz, 20 MPa, 5 seconds, 25° C.), a minimum of 250 W is required to allow copper particles to go through the first 3 stages of the consolidation process: (1) acoustic energy transfer, (2) particle softening and space filling, and (3) particle-to-particle solid-state fusion. Through these three stages full space filling is achieved, and the density of the consolidated part rises above 95% of bulk copper density. FIG. 7 illustrates the compressed powder 500 having a cell structure 516 with dislocation forests 504, dislocation walls 508, and dislocation sources 512. As shown in FIG. 7, microstructurally the boundaries among particles have essentially become grain boundaries and the existence of triple junctions is nearly negligible in the consolidated state. However, the regions near areas where the particle-particle boundaries were located prior to consolidation are now found to have high dislocation densities as evident in the bright field transmission electron image shown in right panel of FIG. 7.

The thermoacoustic ultrasonic roll-forming consolidation system 200 is used to primarily determine the required ultrasonic power level and time at fixed static pressure and temperature (set at ⅓ of power material). Power settings ranging from 50 W to 600 W are used. Static forming time of 0.5 to 10 seconds are used. Multiple tests are conducted to evaluate the effect of temperature and power input. The consolidated feedstock goes through conventional Archimedean density measurements to obtain density values in the consolidated feedstock corresponding to various experimental conditions. A set of optimization experiments are performed with a target condition where the ultrasonic power input stays below 75% duty-cycle, and the static forming time stays below 5 seconds.

First, a mathematical model is developed that describes the relationship between linear powder feed rate (by a linear actuator) and ultrasonic roll-forming die rotation speed. The consolidation zone geometry is such that the height decreases in the powder volume being consolidated, as it goes through the roll-forming process, results in a total volume reduction in the powder. This volume is compared with the volume decrease resulting from advancing the linear actuator. Specifically, the volume change ratio is the same as that of consolidated material density to loose powder apparent density.

Assuming that the powder lost through the space between the roller and the die is negligible and that the friction between the powders and all contact surfaces is minimal the relation below can be used to describe the compaction ratio and density change from loose powder to consolidated feedstock:

$$\frac{w ( 1 - sin Δθ ) cos Δθ}{πΔ x} = \frac{{ρ}_{cons}}{{ρ}_{0}}$$

where w is the width of the roller, Θ is the angle on the roller that encompass the roller-powder contact, ρ_{cons} is the density of the material after consolidation, ρ₀ is the apparent density of the loose powder, and x is the displacement on the linear actuator that feeds the powder. Once the detail geometry and dimensions of the test rig is determined, the equation above is used to define an initial set of feed rates and their corresponding roll-forming die rotation speeds. A scaling factor is applied to the equation above to introduce additional compression, or to reduce compression. Further, over a range of compression amounts, ultrasonic power ranging from 50 W to 600 W is applied to the consolidation process. Resulting density in the consolidated material is examined and documented. The obtained density values are used to determine the optimal value for the scaling factor for a given material.

Once the process-property correlation maps for ultrasonic power input, feed rates, temperature, and product density have been determined, the process can be used to develop a demonstration for specific consolidated wire feedstock dimension and material.

Primarily quality characterization tasks include a range of standard material morphological, physical, and microstructural properties of both the powder, as well as the consolidated wire specimen. Table 1 provides a summary of characterization and testing tasks planned.

TABLE 1
Material Characterization and Testing
Material Testing

| PSD, Morphology | | | Flow, Density | | | | Composition | | |
|---|---|---|---|---|---|---|---|---|---|
| Horiba | Dynamic | SEM | Hall | Apparent | FT4 | FT4 | LECO | LECO | ICP- |
| | Imaging | | Flow | Density | Tapped | SVFR | ONH | CS | MS |
| | (Camsizer) | | | | Density | | | | |

In demonstrating feasibility of the process, the parameters are utilized to design and produce wire feedstock as a technology feasibility demonstration. The initial design for the feedstock is 1.5 mm (or 1/16″) diameter. This is a dimension typically found in welding feedstock. The production mode is semi-continuous in that the loose powder feed and delivery system is based on a linear actuator where during the forward motion of the linear actuator feed, the production process takes place, and the proposed thermoacoustic consolidation process produces F357 feedstock. As seen in FIG. 5, when the linear actuator reaches a pre-set travel limit, the entire process pauses temporarily with the rotation of the roll-forming die, and the ultrasonic energy input stops as the linear actuator retracts and allows for additional powder feedstock to be supplied into the delivery barrel. After the prescribed amount of loose powder feedstock has been re-filled into the barrel, the linear actuator piston moves forward to provide initial pre-compaction. Once the pressure reaches a set value, the thermoacoustic consolidation process resumes with the ultrasonic energy and rotation of the roll-forming die re-activates. By repeating these steps, wire feedstock is produced for testing and demonstration.

In scaling-up the model, a set of the predictions and designs based on these predictions are produced to scale up the proposed thermoacoustic consolidation process. The primary objective is to provide requirements for scaling up the production rate of the process in terms of feedstock size and output speed. To achieve these goals, a mechanical system with higher stiffness is used to provide larger compression. In addition, higher ultrasonic energy, or combining higher ultrasonic energy with higher temperature is used.

The parameters summarized in Table 1 are the performance parameters to quantify parameters relevant to the performance of the thermoacoustic consolidation technology. Table 2 below illustrates the performance parameters achievable via the test rig, and those that are possible via an improved and/or scaled up rig, with further testing.

TABLE 2
Performance Parameters

| | Performance Parameters | | | |
|---|---|---|---|---|
| | | Composition | | |
| | | Deviation from | | |
| | Consolidated | Powder (% | | Maximum |
| | Material | Average | Throughput | Wire |
| | Density | Composition | (cm³ per | Section |
| Metrics | (% of Bulk) | Deviation) | hour) | Length (cm) |
| Test Rig | 80% | 20% | ~5 | 0.5 |
| Improved | 99% | 5% | 50 | 10 |

The global metal powder-based AM market is expected to reach $3 billion USD by 2027. The largest segment of this growth is attributed to the adoption and growth of metal AM parts in aircraft parts in the aerospace industry, increasing adoption by automotive manufacturers, and in energy industrial applications. In order for these projected potentials to be reached, development work that addresses inherent inefficiencies associated with powder use in metal AM processes is a major part of continual innovation in LPBF AM. Cost-effective powder re-claiming or recycle processes (like the technique proposed herein) with low operation and maintenance demands provide a clear path to broad implementation of power recycle systems at the industrial, professional, and even small job-shop levels. The proposed thermoacoustic consolidation process ensures high powder feedstock use efficiency and produces directly usable wire feedstocks for a wide range of applications.

What is claimed is:

1. A method of producing a metal wire feedstock for additive manufacturing and/or welding, the method comprising:
baking a metal powder to remove humidity and moisture from the metal powder;
transferring ultrasonic energy into the metal powder via a roller of a roll-forming die;
transferring vibration energy from the roll-forming die to the metal powder;
converting the metal powder into the metal wire feedstock via solid-state fusion on particle-particle interfaces of the metal powder; and
increasing a ductility of the metal wire feedstock via heat.

2. The method of claim 1, further comprising using the metal powder in a laser powder bed fusion apparatus prior to baking the metal powder, such that the metal powder is a spent metal powder.

3. The method of claim 1, wherein baking the metal powder includes moving the metal powder along a conveyor.

4. The method of claim 3, wherein the conveyor is an auger-type conveyor.

5. The method of claim 3, wherein the conveyor applies an initial compaction force to the metal powder.

6. The method of claim 1, wherein transferring vibration energy from the roll-forming die to the metal powder provides acoustic softening and frictional heating to the metal powder.

7. The method of claim 1, wherein increasing the ductility of the metal wire feedstock via heat includes receiving heat from an external heat source.

8. A method of recycling a spent metal powder from a laser powder bed fusion apparatus, the method comprising:
applying heat at a temperature less than a melting temperature of the spent metal powder to the spent metal powder;
applying ultrasonic vibration energy to the spent metal powder; and
forming, via the applied heat and ultrasonic vibration energy, a wire feedstock.

9. The method of claim 8, further comprising utilizing the wire feedstock in a directed energy deposition apparatus or a wire arc additive manufacturing apparatus.

10. The method of claim 8, further comprising utilizing the wire feedstock in a metal inert gas welder or a tungsten inert gas welder.

11. A thermoacoustic ultrasonic roll-forming consolidation system comprising:
a hopper configured to receive a metal powder;
a shaping anvil;
a roller configured to rotate relative to the shaping anvil, wherein a compression and consolidation zone is formed by and between the roller and the shaping anvil;
a conveyor configured to convey the metal powder from the hopper to the compression and consolidation zone,
wherein the roller and the shaping anvil are configured to convert the metal powder into a metal wire feedstock via solid-state fusion on particle-particle interfaces of the metal powder.

12. The thermoacoustic ultrasonic roll-forming consolidation system of claim 11, further comprising an ultrasonic transducer, wherein the roller is configured to transfer ultrasonic energy from the ultrasonic transducer into the metal powder.

13. The thermoacoustic ultrasonic roll-forming consolidation system of claim 11, further comprising a heat source configured to bake the metal powder at the conveyor.

14. The thermoacoustic ultrasonic roll-forming consolidation system of claim 11, wherein the roller includes a semicircular profile, wherein the shaping anvil has a semicircular profile, wherein the semicircular profiles of the roller and the shaping anvil cooperate to form a circular cross-section of the metal wire feedstock.

15. The thermoacoustic ultrasonic roll-forming consolidation system of claim 11, wherein the conveyor includes an auger configured to transfer the metal powder away from the hopper and towards the compression and consolidation zone.

16. The thermoacoustic ultrasonic roll-forming consolidation system of claim 11, wherein the roller is supported by a pair of bearings.

17. The thermoacoustic ultrasonic roll-forming consolidation system of claim 11, wherein the conveyor applies an initial compaction force to the metal powder.

18. The thermoacoustic ultrasonic roll-forming consolidation system of claim 11, wherein the conveyor includes an auger, and wherein the roller is rotatable about an axis that is perpendicular to a rotational axis of the auger.

19. The thermoacoustic ultrasonic roll-forming consolidation system of claim 11, wherein the conveyor includes a linear actuator, and wherein the roller is rotatable about an axis that is perpendicular to a motion direction of the linear actuator.

20. The thermoacoustic ultrasonic roll-forming consolidation system of claim 11, wherein a diameter of the metal wire feedstock is less than an inner diameter of the conveyor.
